(19) United States
(12) Patent Application Publication
(10) Pub. No.: US 2012/0210894 A1
(43) Pub. Date: Aug. 23, 2012

(54) RELIEF PRINTING PLATE PRECURSOR FOR LASER ENGRAVING AND PROCESS FOR PRODUCING SAME, AND RELIEF PRINTING PLATE AND PROCESS FOR MAKING SAME

(75) Inventor: Hiroyuki Nagase, Haibara-gun (JP)

(73) Assignee: FUJIFILM Corporation, Tokyo (JP)

(21) Appl. No.: 13/402,046

(22) Filed: Feb. 22, 2012

(30) Foreign Application Priority Data
Feb. 22, 2011 (JP) 2011-036362

(51) Int. Cl. B41N 1/06; B32B 7/02; B23H 1/00

(52) U.S. Cl. 101/395; 264/400; 428/212; 156/272.8

(57) ABSTRACT

A relief printing plate precursor for laser engraving that comprises a photocured layer, and a thermally cured layer, on a support in this order, the photocured layer being a layer obtained by photocuring a layer comprising (Component A) an ethylenically unsaturated compound, (Component B) a photopolymerization initiator, and (Component C) particles, and the photocured layer and the thermally cured layer satisfying the relation of following Formula (1).

(Elastic modulus of the photocured layer)<(Elastic modulus of the thermally cured layer) (1)

### BACKGROUND OF THE INVENTION

1. Technical Field

The present invention relates to a relief printing plate precursor for laser engraving and a process for producing the same, and a relief printing plate and a process for making the same.

2. Background Art

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

As the relief printing plate precursor for laser engraving, those described in JP-A-2010-76387 (JP-A denotes a Japanese unexamined patent application publication), JP-A-2010-76384, JP-A-2009-72964, or JP-A-2008-221471 are known.

### SUMMARY OF THE INVENTION

### Problems to be Solved by the Invention

It is an object of the present invention to provide a relief printing plate precursor for laser engraving, which is inexpensive and has excellent resolution power and ink transfer properties, a method for producing the printing plate precursor, and a relief printing plate using the relief printing plate precursor for laser engraving, and a method for making the printing plate.

The problems of the present invention described above have been solved by the means described in following <1>, <8>, <16> and <18>. Preferred embodiments <2> to <7>, <9> to <15> and <17> will also be described below.

<1> A relief printing plate precursor for laser engraving, having a photocured layer and a thermally cured layer on a support in this order, the photocured layer being a layer obtained by photocuring a layer containing (Component A) an ethylenically unsaturated compound, (Component B) a photopolymerization initiator, and (Component C) particles, and the photocured layer and the thermally cured layer satisfying the relation of following Formula (1):

(Elastic modulus of the photocured layer)<(Elastic modulus of the thermally cured layer) (1),

<2> the relief printing plate precursor for laser engraving according to <1>, wherein Component A includes a (meth)acrylate compound,

<3> the relief printing plate precursor for laser engraving according to <1> or <2>, wherein Component C is inorganic particles,

<4> the relief printing plate precursor for laser engraving according to any one of <1> to <3>, wherein the thermally cured layer contains a binder polymer and a photo-thermal conversion agent,

<5> the relief printing plate precursor for laser engraving according to <4>, wherein the photo-thermal conversion agent is a photo-thermal conversion agent capable of absorbing light having a wavelength of 700 to 1,300 nm,

<6> the relief printing plate precursor for laser engraving according to <4> or <5>, wherein the photo-thermal conversion agent is carbon black,

<7> the relief printing plate precursor for laser engraving according to any one of <1> to <6>, wherein the thermally cured layer is a layer obtained by thermally curing a layer containing a polymerizable compound,

<8> a method for producing a relief printing plate precursor for laser engraving, the method including a layer forming step of forming a thermally curable layer on a substrate; a thermal curing step of thermally curing the thermally curable layer and thereby forming a thermally cured layer; a preparation step of preparing a photocurable composition containing (Component A) an ethylenically unsaturated compound, (Component B) a photopolymerization initiator, and (Component C) particles having a diameter of 5 to 100 μm; a bonding step of applying the photocurable composition, and bonding the thermally curable layer or the thermally cured layer and a support; and a photocuring step of curing the photocurable composition with light to form a photocured layer, and adhering the thermally curable layer or the thermally cured layer and the support, the photocured layer and the thermally cured layer satisfying the relation of following Formula (1):

(Elastic modulus of photocured layer)<(Elastic modulus of thermally cured layer) (1),

<9> the method for producing a relief printing plate precursor for laser engraving according to <8>, wherein Component A includes a (meth)acrylate compound,

<10> the method for producing a relief printing plate precursor for laser engraving according to <8> or <9>, wherein Component C is inorganic particles,

<11> the method for producing a relief printing plate precursor for laser engraving according to any one of <8> to <10>, wherein curing is achieved by light having a wavelength of 200 to 600 nm in the photocuring step,

<12> the method for producing a relief printing plate precursor for laser engraving according to any one of <8> to <11>, wherein the thermally cured layer contains a binder polymer and a photo-thermal conversion agent,

<13> the method for producing a relief printing plate precursor for laser engraving according to <12>, wherein the photo-thermal conversion agent is a photo-thermal conversion agent capable of absorbing light having a wavelength of 700 to 1,300 nm,

<14> the method for producing a relief printing plate precursor for laser engraving according to <12> or <13>, wherein the photo-thermal conversion agent is carbon black,

<15> the method for producing a relief printing plate precursor for laser engraving according to any one of <8> to <14>, wherein the thermally curable layer contains a polymerizable compound,

<16> a method for making a relief printing plate, the method including an engraving step of laser-engraving the thermally cured layer of the relief printing plate precursor for laser engraving according to any one of <1> to <7> or a relief printing plate precursor for laser engraving obtained by the method according to any one of <8> to <15>, and forming a relief layer,

<17> the method for making a relief printing plate according to <16>, wherein engraving is carried out with a fiber-coupled semiconductor laser light having a wavelength of 700 to 1,300 nm in the engraving step, and

<18> a relief printing plate having a relief layer produced by the method for making a relief printing plate according to <16> or <17>.

### BRIEF DESCRIPTION OF DRAWINGS

FIG. 1 is a schematic diagram showing an example of the production apparatus used in the method for producing a relief printing plate precursor of the present invention.

### REFERENCE NUMERALS

10: Production apparatus for relief printing plate precursor
12: Thermally cured layer
12a: Surface facing the surface of thermally cured layer 12 on the substrate side (air surface)
12b: Surface of Thermally cured layer 12 on the substrate side
14: Thermally cured layer roller
16: Conveying means
18: Adhesive applicator
20: Photocurable layer
22: Support roller
24: Support
26, 28: Nip rollers
30: Ultraviolet irradiation means
32: Relief printing plate precursor

### MODE FOR CARRYING OUT THE INVENTION

The present invention is explained in detail below. In the present invention, the notation ‘lower limit to upper limit’ expressing a numerical range means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

In the present invention, “(Component A) an ethylenically unsaturated compound” etc. are simply called “Component A” etc.

### (Relief Printing Plate Precursor for Laser Engraving)

The relief printing plate precursor for laser engraving (hereinafter, also simply called “relief printing plate precursor”) of the present invention has a photocured layer and a thermally cured layer on a support in this order, and the photocured layer is a layer obtained by photocuring a layer containing (Component A) an ethylenically unsaturated compound, (Component B) a photopolymerization initiator, and (Component C) particles, while the photocured layer and the thermally cured layer satisfy the relation of following Formula (1):

(Elastic modulus of the photocured layer)<(Elastic modulus of the thermally cured layer) (1)

Relief printing plate precursors for laser engraving have a problem that when the recording layer (thermally cured layer) is hardened, that is, the elastic modulus is increased, the resolution power increases; however, when the recording layer is hardened, ink transfer properties are deteriorated. The present inventors conducted a thorough investigation, and as a result, they found that when a relief printing plate precursor for laser engraving is made to have a two-layer configuration of a lower layer (photocured layer) that is soft, that is, has a small elastic modulus, and a recording layer (thermally cured layer), the resolution power increases, and also, the ink transfer properties are not deteriorated but, rather, are enhanced.

Furthermore, in regard to relief printing plate precursors for laser engraving, generally, the material cost for the recording layer, that is, the thermally cured layer according to the present invention, is high. On the other hand, the photocured layer requires a lower material cost compared to the thermally cured layer, and since the photocured layer contains particles, the material cost can be further lowered.

### <Elastic Moduli of Photocured Layer and Thermally Cured Layer>

In the relief printing plate precursor for laser engraving of the present invention, the photocured layer and the thermally cured layer satisfy the relation of following Formula (1):

(Elastic modulus of the photocured layer)<(Elastic modulus of the thermally cured layer) (1)

That is, the photocured layer in the relief printing plate precursor for laser engraving of the present invention is a layer having a smaller elastic modulus (also called “coefficient of elasticity”) than the thermally cured layer.

The method for measuring the elastic moduli of the photocured layer and the thermally cured layer is not particularly limited, and measurement may be made by any known measurement method. Specifically, a preferred example of the measurement method such as follows may be used. A DMS6100 manufactured by SII Nanotechnology, Inc. is used, and as the measurement conditions, a specimen having a width of 6 mm is held with a sample holder, the measurement length is set to 10 mm, the specimen is heated from −30° C. to 50° C. at a rate of temperature increase of 4° C./min. Meanwhile, a dynamic viscoelasticity analysis is carried out in a tensile mode at 100 Hz, with the maximum strain ratio set at 0.1%, temperature calibration of the apparatus is carried out by measuring the difference between the temperature indicated by a thermocouple attached to the specimen and the temperature indicated by the apparatus, and the storage elastic modulus (E′) at 100 Hz at 25° C. is determined. The thickness of the specimen may be measured separately by a known method.

Furthermore, the elastic modulus according to the present invention is preferably a storage elastic modulus E′, which is a real number component of the complex elastic modulus E*.

The storage elastic modulus E′ of the photocured layer is not particularly limited as long as the storage elastic modulus has a smaller value than that of the thermally cured layer. However, from the viewpoint of ink transfer properties, the storage elastic modulus is preferably 1 to 15 MPa, more preferably 5 to 12 MPa, and even more preferably 5 to 10 MPa.

Furthermore, the storage elastic modulus E′ of the thermally cured layer is not particularly limited as long as the value is larger than the value of the photocured layer, but from the viewpoint of resolution power, the storage elastic modulus is preferably 5 to 50 MPa, more preferably greater than 10 MPa and equal to or less than 30 MPa, and even more preferably greater than 12 MPa and equal to or less than 20 MPa.

### <Support>

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. Among them, the support is preferably a transparent support, and more preferably a PET film.

### <Photocured Layer>

The relief printing plate precursor for laser engraving (hereinafter, also simply called “relief printing plate precursor”) of the present invention has a photocured layer and a thermally cured layer on a support in this order, and the photocured layer is a layer obtained by photocuring a layer containing (Component A) an ethylenically unsaturated compound, (Component B) a photopolymerization initiator, and (Component C) particles.

Furthermore, according to the present invention, the “layer containing (Component A) an ethylenically unsaturated compound, (Component B) a photopolymerization initiator, and (Component C) particles” is also called a “layer formed from a photocurable composition.”

The light used to cure the photocured layer is not particularly limited, and the light is preferably α-rays, γ-rays, X-rays, ultraviolet rays, visible rays, electron beams or the like. However, the light is preferably ultraviolet rays and/or visible rays, and more preferably a light having a wavelength of 200 to 600 nm, which is in the range of near-ultraviolet-visible rays.

Meanwhile, the term “curing” according to the present invention means that the substance becomes harder than the state before curing.

The thickness of the photocured layer is preferably 0.3 to 2 mm, preferably 0.4 to 1.0 mm, more preferably 0.5 to 0.9 mm, and particularly preferably 0.7 to 0.9 mm, from the viewpoint of cost or ink transfer properties.

Furthermore, it is preferable that the thickness of the photocured layer and the thickness of the thermally cured layer satisfy following Formula (2), from the viewpoint of cost or ink transfer properties.

(Thickness of the photocured layer)≧(Thickness of the thermally cured layer) (2)

### (Component A) Ethylenically Unsaturated Compound

The photocured layer is a layer obtained by photocuring a layer containing (Component A) an ethylenically unsaturated compound.

Here, the ethylenically unsaturated compound is a compound having at least one or more ethylenically unsaturated groups. The ethylenically unsaturated compound is such that one kind may be used alone, or two or more kinds may be used in combination.

Examples of the ethylenically unsaturated compound include unsaturated carboxylic acids (for example, acrylic acid, methacrylic acid, itaconic acid, crotonic acid, isocrotonic acid, and maleic acid), esters thereof, and amides thereof.

Further examples include addition reaction products of an unsaturated carboxylic acid ester or amide having a nucleophilic substituent such as a hydroxyl group, an amino group or a mercapto group, and a monofunctional or polyfunctional isocyanate or epoxy, and dehydration condensation reaction products of a monofunctional or polyfunctional carboxylic acid.

Further examples also include addition reaction products of an unsaturated carboxylic acid ester or amide having an electrophilic substituent such as an isocyanate group or an epoxy group, and a monofunctional or polyfunctional alcohol, amine or thiol; and substitution reaction products of an unsaturated carboxylic acid ester or amide having a leaving substituent such as a halogeno group or a tosyloxy group, and a monofunctional or polyfunctional alcohol, an amine or a thiol.

As other examples, it is also possible to use a group of substitute compounds such as vinyl compounds, allyl compounds, unsaturated phosphonic acids, and styrene, instead of the unsaturated carboxylic acids described above.

As the ethylenically unsaturated compound that can be used in the present invention, from the viewpoint of reactivity, a (meth)acrylate compound, a vinyl compound, and an allyl compound are preferred, and a (meth)acrylate compound is particularly preferred.

According to the present invention, the term “(meth)acryl” includes any one of “acryl” and “methacryl”, or both of them, and “(meth)acrylate” includes any one of “acryl” and “methacryl”, or both of them.

Furthermore, preferable examples of the ethylenically unsaturated compound include compounds represented by following Formula (A-1) to Formula (A-7).

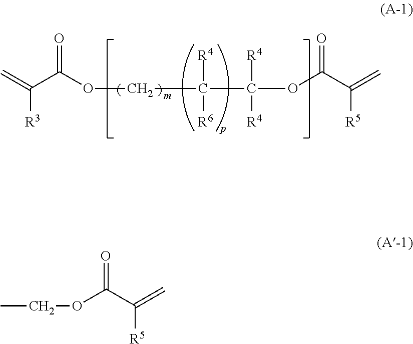

In Formula (A-1), R³ represents a hydrogen atom or —CH₃; R⁴s each independently represent a hydrogen atom, —CH₃, —C₂H₅, or a group represented by Formula (A′-1); R⁵s each independently represent a hydrogen atom, a chlorine atom, —CH₃ or —C₂H₅; R⁶s each independently represent a hydrogen atom or a group represented by Formula (A′-1); m's each independently represent an integer from 1 to 8; n represents an integer from 1 to 20; and p's each independently represent 0 or 1.

Specific examples of the compound represented by Formula (A-1) include diethylene glycol di(meth)acrylate, triethylene glycol di(meth)acrylate, tetraethylene glycol di(meth)acrylate, 1,2-propylene glycol di(meth)acrylate, dipropylene glycol di(meth)acrylate, polyethylene glycol di(meth)acrylate, glycerin tri(meth)acrylate, trimethylolpropane tri(meth)acrylate, and diglycerol tetra(meth)acrylate.

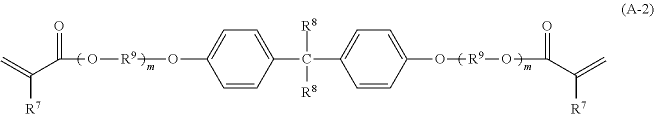

In Formula (A-2), R⁷s each independently represent a hydrogen atom or —CH₃; R⁸s each independently represent a hydrogen atom or a linear or branched alkyl group having 1 to 4 carbon atoms; R⁹s each independently represent a linear or branched alkylene group having 2 to 4 carbon atoms; and m's each independently represent an integer from 1 to 10.

Specific examples of the compound represented by Formula (A-2) include 2,2-bis(4-methacryloxydiethoxyphenyl)propane, 2,2-bis(4-methacryloxytriethoxyphenyl)propane, 2,2-bis(4-acryloxypentaethoxyphenyl)propane, 2,2-bis(4-methacryloxyhexaethoxyphenyl)propane, 2,2-bis(4-acryloxyheptaethoxyphenyl)propane, 2,2-bis(4-methacryloxyoctaethoxyphenyl)propane, 2,2-bis(4-acryloxydipropoxyphenyl)propane, 2,2-bis(4-methacryloxytripropoxyphenyl)propane, 2,2-bis(4-acryloxydibutyoxyphenyl)propane, 2,2-bis(4-methacryloxyoctadibutoxyphenyl)propane, 2-(4-methacryloxydiethoxyphenyl)-2-(4-methacryloxytriethoxyphenyl)propane, and 2-(4-acryloxydipropoxyphenyl)-2-(4-acryloxytriethoxyphenyl)propane.

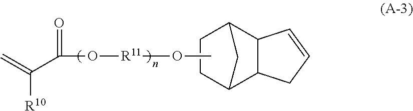

In Formula (A-3), R¹⁰ represents a hydrogen atom or —CH₃; R¹¹s each independently represent a hydrogen atom or a linear or branched alkyl group having 1 to 4 carbon atoms; and n represents an integer from 0 to 10.

Specific examples of the compound represented by Formula (A-3) include dicyclopentenyl(meth)acrylate, dicyclopentenyloxyethyl(meth)acrylate, and dicyclopentenyloxypropyl(meth)acrylate.

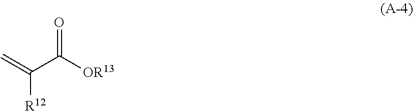

In Formula (A-4), R¹² represents a hydrogen atom or —CH₃; R¹³ represents a hydrogen atom, a linear or branched alkyl group having 1 to 18 carbon atoms; a cyclic alkyl group having 5 to 20 carbon atoms, a phenyl group, a tetrahydrofurfuryl group, or a linear or branched alkyl group having 5 to 20 carbon atoms and having these groups.

Specific examples of the compound represented by Formula (A-4) include methacrylic acid, acrylic acid, methyl(meth)acrylate, cyclohexyl(meth)acrylate, tetrahydrofurfuryl(meth)acrylate, 2-ethylhexyl(meth)acrylate, phenyl(meth)acrylate, and benzyl(meth)acrylate.

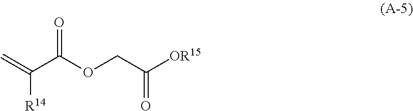

In Formula (A-5), R¹⁴ represents a hydrogen atom, or —CH₃; R¹⁵ represents a linear or branched alkyl group having 1 to 20 carbon atoms, an alkenyl group, an aryl group, an aralkyl group, or a linear or branched alkoxyalkyl group.

Specific examples of the compound represented by Formula (A-5) methoxycarbonylmethyl(meth)acrylate, ethoxycarbonylmethyl(meth)acrylate, heptoxycarbonylmethyl(meth)acrylate, and isopropoxycarbonylmethyl(meth)acrylate.

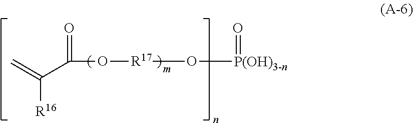

In Formula (A-6), R¹⁶s each independently represent a hydrogen atom or —CH₃; R¹⁷s each independently represent a linear or branched alkylene group having 2 to 4 carbon atoms; m's each independently represent an integer from 1 to 10; and n represents 1 or 2

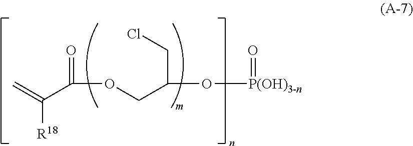

In Formula (A-7), R¹⁸s each independently represent a hydrogen atom or —CH₃; m's each independently represent an integer from 1 to 10; and n represents 1 or 2.

Specific examples of the compound represented by Formula (A-6) or Formula (A-7) include (meth)acryloxyethyl phosphoric acid, 1-chloro-3-(meth)acryloxypropyl-2-phosphoric acid, and (meth)acryloxypropyl phosphoric acid.

Furthermore, as the ethylenically unsaturated compound, a (meth)acrylate compound having a urethane bond can be used.

Examples of the (meth)acrylate compound having a urethane bond include a reaction product of a (meth)acrylate compound having a hydroxyl group and an organic polyisocyanate compound; and a reaction product of a (meth)acrylate compound having a hydroxyl group, an organic polyisocyanate compound, and a polyol compound and/or diol compound having a valence of 3 or higher.

As a specific example, bis(glycerylurethane)isophorone tetramethacrylate (compound shown below) may be mentioned as a preferable example.

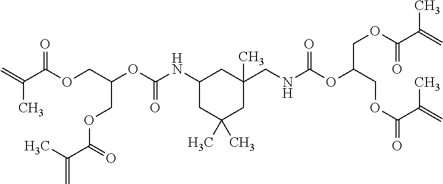

For the ethylenically unsaturated compound, one kind may be used alone, or two or more kinds may be used in combination.

The content of the ethylenically unsaturated compound in the photocurable composition forming the photocured layer is preferably 10 to 90 parts by weight, and more preferably 20 to 80 parts by weight, relative to 100 parts by weight of the photocurable composition.

### (Component B) Photopolymerization Initiator

The photocured layer is a layer obtained by photocuring a layer containing (Component B) a photopolymerization initiator.

The photopolymerization initiator is not particularly limited, and any known initiator can be used, but the initiator is preferably a photoradical polymerization initiator.

Examples of the photopolymerization initiator include (a) aromatic ketones, (b) onium salt compounds, (d) thio compounds, (e) hexaaryl biimidazole compounds, (f) keto-oxime ester compounds, (g) borate compounds, (h) azinium compounds, (i) metallocene compounds, (j) active ester compounds, and (k) compounds having a carbon-halogen bond. Examples of these photopolymerization initiators include the compounds described in JP-A No. 2008-19408.

Specific examples of the photopolymerization initiator are described extensively in, for example, Bruce M. Monroe, et al., Chemical Reviews, 93, 435 (1993); R. S. Davidson, Journal of Photochemistry and Biology A: Chemistry, 73, 81 (1993); J. P. Faussier, “Photoinitiated Polymerization—Theory and Applications”; Rapra Review, Vol. 9, Report, Rapra Technology (1998); and M. Tsunooka et al., Prog. Polym. Sci., 21, 1 (1996). Furthermore, many compounds that are used in chemically amplified photoresists as photopolymerization initiators, are extensively described in the Japanese Research Association for Organic Electronics Materials, Ed., “Organic Materials for Imaging”, Bunshin Printing Co., Ltd. (1993), pages 187-192. Furthermore, a group of compounds which cause oxidative or reductive bonding and cleavage through an interaction with the electron-excited state of sensitizers, as described in F. D. Saeva, Topics in Current Chemistry, 156, 59 (1990); G. G. Maslak, Topics in Current Chemistry, 168, 1 (1993); H. B. Shuster, et al., J. Am. Chem. Soc., 112, 6329 (1990); I. D. F. Eaton et al., J. Am. Chem. Soc., 102, 3298 (1980), and the like, are also known as photopolymerization initiators.

Furthermore, specific examples of the polymerization initiator include benzyl, benzophenone, Michler's ketone, 2-chlorothioxanthone, 2,4-diethylthioxanthone, benzoin, benzoin ethyl ether, benzoin isobutyl ether, benzoin octyl ether, diethoxyacetophenone, benzyl methyl ketal, 1-hydroxycyclohexyl phenyl ketone, diacetyl, methylanthraquinone, acetophenone, 2-hydroxy-2-methylpropiophenone, anthraquinone, and 3,3′,4,4′-tetra(tertiary-butylperoxycarbonyl)benzophenone.

The photopolymerization initiator may be used individually, or two or more kinds may be used in combination.

The content of the photopolymerization initiator in the photocurable composition that form the photocured layer is preferably 0.1 to 20 parts by weight, and more preferably 0.1 to 10 parts by weight, relative to 100 parts by weight of the photocurable composition.

### (Component C) Particles

The photocured layer is a layer obtained by photocuring a layer containing (Component C) particles.

The volume average particle size (volume average primary particle size) of Component C is preferably 5 to 100 μm, more preferably 5 to 80 μm, and even more preferably 10 to 70 μm. When the volume average particle size is in the above-described range, light scattering can be suppressed at the time of photocuring, curability is excellent, and the planarity of the photocured layer is excellent.

The method for measuring the volume average particle size of Component C is not particularly limited, and measurement can be made by any known measurement method.

The shape of Component C that can be used in the present invention is not particularly limited, and examples include a spherical shape, a layered shape, a plate shape, a fibrous shape, and a hollow balloon shape. Among these, the shape of Component C is preferably a spherical shape or a layered shape, and is more preferably a spherical shape.

As Component C that can be used in the present invention, known particles can be used as a filler, and for example, the particles may be inorganic particles or organic resin particles. The particles are preferably inorganic particles from the viewpoint of dispersion stability in the photocurable composition, the elastic modulus of the photocurable layer, and the resolution power.

Examples of the inorganic particles include particles of alumina, titania, zirconia, kaolin, calcined kaolin, talc, pyrophyllite, diatomaceous earth, calcium carbonate, aluminum hydroxide, magnesium hydroxide, zinc oxide, lithopone, amorphous silica, colloidal silica, calcined gypsum, silica, magnesium carbonate, titanium oxide, alumina, barium carbonate, barium sulfate, and mica.

Among these, silica or alumina is preferable, and silica is particularly preferable.

Furthermore, as the layered inorganic particles, an inorganic layered compound having a thin flat sheet shape may be preferable, and examples include a group of micas such as natural mica and synthetic mica as represented by the following formula, talc represented by 3MgO.4SiO.H₂O, taeniolite, montmorillonite, saponite, hectorite, and zirconium phosphate.

A(B,C)₂₋₅D₄O₁₀(OH,F,O)₂

wherein A represents any one of K, Na and Ca; B and C each represent any one of Fe(II), Fe(III), Mn, Al, Mg and V; and D represents Si or Al.

As Component C that can be used in the present invention, commercially available products shown below may be mentioned as preferable examples. Meanwhile, the numerical values in the parentheses represent an average particle size.

Examples of spherical silica particles include Silica Gel 60 (40 to 50 μm) and Silica Gel 60N (40 to 50 μm) manufactured by Kanto Chemical Co., Inc.; Sunsphere H-51 (5 μm), H-121 (12 μm), H-201 (20 μm), L-51 (5 μm), P-100 (10 μm), and NP-200 (20 μm), all manufactured by AGC Si-Tech Co., Ltd.

Furthermore, examples of alumina particles include A11 (50 μm), A12 (50 μm), A13 (50 μm), A14 (50 μm), A21 (80 μm), A23 (80 μm), and A31 (5 μm), all manufactured by Nippon Light Metal Co., Ltd.

With regard to Component C, there may be only one type, or two or more different types may be used in combination.

The content of Component C in the photocured layer is preferably 1 to 70 wt %, more preferably 5 to 60 wt %, and even more preferably 10 to 50 wt %, relative to the total weight of the photocured layer. When the content is in the above-described range, the cost can be decreased to a low level, a decrease in the strength in the case of producing a photocured layer having a thickness of 500 μm can be suppressed, and strike-slip of the thermally cured layer can be prevented.

The content of Component C in the photocurable composition that forms the photocured layer is preferably 1 to 70 parts by weight, more preferably 5 to 60 parts by weight, and even more preferably 10 to 50 parts by weight, relative to 100 parts by weight of the photocurable composition. When the content is in the above-described range, the cost can be decreased to a low level, a decrease in the strength in the case of producing a photocured layer having a thickness of about 500 μm can be suppressed, and strike-slip of the thermally cured layer can be prevented.

### (Component D) Other Components

The photocured layer, and the photocurable composition that forms the photocured layer may contain known additives according to necessity, in addition to the components described above, but it is preferable that the photocured layer and the photocurable composition do not contain additional components other than the components described above.

Examples of the additives include a polymerization accelerating agent, a stabilizer, a colorant, and a viscosity adjusting agent.

Examples of the polymerization accelerating agent include 1,2,3,4-tetrahydroquinoline, saccharin, triethylamine, and N,N-dimethylaniline.

Examples of the stabilizer include oxalic acid, dinitrosoresorcinol, and quinones.

Examples of the viscosity adjusting agent include polymer compounds such as resins, and organic solvents.

The photocurable composition may contain a volatile organic compound (VOC) that does not have an ethylenically unsaturated group, such as an organic solvent, but it is preferable that the photocurable composition does not contain the volatile organic compound, and more preferably contain Component A to Component C only.

### <Thermally Cured Layer>

The relief printing plate precursor for laser engraving (hereinafter, also simply referred to as “relief printing plate precursor”) of the present invention has a photocured layer and a thermally cured layer on a support in this order.

The thermally cured layer is a layer cured by heat, and is not particularly limited as long as it is a layer capable of laser-engraving. However, the thermally cured layer is preferably a layer formed from a resin composition for laser engraving that will be described below.

More particularly, the thermally cured layer is more preferably a layer obtained by forming a resin composition for laser engraving in a layer form, and thermally crosslinking the resin composition, and when the resin composition for laser engraving contains a solvent, the thermally cured layer is more preferably a layer obtained by forming a resin composition for laser engraving in a layer form, removing the solvent, and thermally crosslinking the resin composition.

Furthermore, the thermally cured layer preferably has a crosslinked structure.

The thermally cured layer also preferably contains a binder polymer and a photothermal conversion agent. The binder polymer and the photothermal conversion agent will be described in detail in relation to the resin composition for laser engraving that will be described later.

The thermally cured layer may be subjected not only to curing by heat, but also to polymerization by light.

The thickness of the thermally cured layer is preferably 0.5 to 1 mm, more preferably 0.5 to 0.9 mm, and particularly preferably 0.5 to 0.7 mm, from the viewpoint of cost or ink transfer properties.

### —Resin Composition for Laser Engraving —

The thermally cured layer is preferably formed from the resin composition for laser engraving.

The resin composition for laser engraving (hereinafter, also simply referred to as “resin composition”) that can be used in the present invention preferably contains a binder polymer, more preferably contains a binder polymer and a photothermal conversion agent, even more preferably contains a binder polymer, a photothermal conversion agent and a crosslinking agent, and particularly preferably contains a binder polymer, a photothermal conversion agent, and a reactive silane compound.

Furthermore, the thermally cured layer is preferably a layer obtained by curing by thermally crosslinking a layer formed from a resin composition for laser engraving. When the resin composition for laser engraving contains a solvent, it is preferable to remove the solvent from the resin composition for laser engraving before thermally curing the resin composition. There are no particular limitations on the crosslinking, and at least one among the components constituting the resin composition for laser engraving may be crosslinked. For example, crosslinking may be carried out between binder polymers that will be described below, crosslinking may be carried out between crosslinking agents that will be described below, and crosslinking may also be carried out between a binder polymer and a crosslinking agent.

### Binder Polymer

The resin composition for laser engraving preferably contains a binder polymer (hereinafter, also referred to as “binder”).

The binder is a polymer component contained in the resin composition for laser engraving, and general polymer compounds can be appropriately selected and used singly or in combination of two or more kinds. Particularly, when the resin composition for laser engraving is used for a printing plate precursor, it is necessary to select the binder in consideration of various performances such as laser engraving properties, ink receptibility, and engraving residue dispersibility.

A binder can be selected from a polystyrene resin, a polyester resin, a polyamide resin, a polyurea resin, a polyamideimide resin, a polyurethane resin, a polysulfone resin, a polyether sulfone resin, a polyimide resin, a polycarbonate resin, a hydrophilic polymer containing a hydroxyethylene unit, an acrylic resin, an acetal resin, an epoxy resin, a polycarbonate resin, a rubber, a thermoplastic elastomer and the like, and be used.

For example, from the viewpoint of laser engraving sensitivity, a polymer comprising a partial structure that is thermally decomposed by exposure or heating is preferable. As such polymer, those described in JP-A-2008-163081, paragraph 0038 are preferably cited. Moreover, when a purpose is to form a film that has softness and flexibility, a soft resin or a thermoplastic elastomer is selected. There is detailed description in JP-A-2008-163081, paragraphs 0039 to 0040. Furthermore, in the case where the resin composition for laser engraving is applied to the relief-forming layer in the relief printing plate precursor for laser engraving, from the viewpoint of easiness of preparing a composition for the relief-forming layer and improvement of resistance properties for an oil-based ink in the relief printing plate to be obtained, the use of a hydrophilic or alcoholphilic polymer is preferable. As the hydrophilic polymer, those described in detail in JP-A-2008-163081, paragraph 0041 can be used.

Similarly, when it is used for the purpose of curing by heat or light exposure and improving strength, a polymer having a carbon-carbon unsaturated bond in the molecule is preferably used.

As a polymer having a carbon-carbon unsaturated bond in the main chain, SI (polystyrene-polyisoprene), SB (polystyrene-polybutadiene), SBS (polystyrene-polybutadiene-polystyrene), SIS (polystyrene-polyisoprene-polystyrene), SEBS (polystyrene-polyethylene/polybutylene-polystyrene), etc. can be cited.

A polymer having a carbon-carbon unsaturated bond in a side chain may be obtained by introducing, into a side chain of the skeleton of the binder polymer applicable in the present invention, a carbon-carbon unsaturated bond such as an allyl group, an acryloyl group, a methacryloyl group, a styryl group, or a vinyl ether group. As a method for introducing a carbon-carbon unsaturated bond into a binder polymer side chain, a known method such as a method in which a polymer is copolymerized with a structural unit having a polymerizable group precursor formed by bonding a protecting group to a polymerizable group, and the protecting group is removed to give a polymerizable group or a method in which a polymer compound having a plurality of reactive groups such as hydroxy groups, amino groups, epoxy groups, or carboxy groups is prepared and a polymer reaction is carried out with a compound having a carbon-carbon unsaturated bond and a group that reacts with these reactive groups may be employed. In accordance with these methods, the amount of unsaturated bond and polymerizable group introduced into the polymer compound can be controlled.

As the binder, the use of a polymer having a hydroxyl group (—OH) (hereinafter, also referred to as the “specific polymer”) is particularly preferable. As the skeleton of the specific polymer, although not particularly limited, an acrylic resin, an epoxy resin, hydrophilic polymers containing a hydroxyethylene unit, a polyvinylacetal resin, a polyester resin and a polyurethane resin are preferable.

Examples of the acrylic monomers used for synthesizing an acrylic resin having a hydroxyl group include preferably (meth)acrylic acid esters, crotonic acid esters and (meth)acrylamides having a hydroxyl group in the molecule. Specific examples of such monomers include 2-hydroxyethyl (meth)acrylate, 2-hydroxypropyl(meth)acrylate, 4-hydroxybutyl(meth)acrylate etc. Copolymers obtained by copolymerizing these with a known (meth)acrylic-based monomer or vinyl-based monomer are used preferably.

As the specific polymer, the use of an epoxy resin having a hydroxyl group on the side chain may also be possible. As a preferable specific example, an epoxy resin obtained by polymerizing an adduct of bisphenol A and epichlorohydrin as raw material monomers is cited.

As the polyester resin, a polyester resin containing a hydroxycarboxylic acid unit such as polylactic acid is preferably used. Specifically, the polyester resin selected from the group consisting of polyhydroxy alkanoate (PHA), lactic acid-based polymer, polyglycolic acid (PGA), polycaprolactone (PCL), poly(butylenesuccinic acid), derivatives and mixtures thereof is preferable.

As the specific polymer, a polymer having an atom and/or a group capable of reacting with the above-mentioned compound (I) is preferable, and a binder polymer that has an atom and/or a group capable of reacting with the compound (I) and is insoluble in water and soluble in an alcohol having 1 to 4 carbon atoms is more preferable.

Examples of the atom and/or the group capable of reacting with the compound (I) include, although not particularly limited, an ethylenically unsaturated bond, an epoxy group, an amino group, a (meth)acryloyl group, a mercapto group and a hydroxyl group, and, among these, a hydroxyl group is exemplified preferably.

Examples of preferable specific polymers in the present invention include polyvinyl butyral (PVB), acrylic resin having a hydroxyl group on the side chain, epoxy resin having a hydroxyl group on the side chain etc., from the viewpoint of having high engraving sensitivity and good film performance while satisfying both the aptitude for an aqueous ink and the aptitude for a UV ink.

The specific polymer usable for the present invention gives particularly preferably a glass transition temperature (Tg) of at least 20° C., when combined with a photothermal conversion agent capable of absorbing light having a wavelength of 700 to 1,300 nm to be described later, which is a preferable combining component of the resin composition for laser engraving constituting the recording layer in the present invention, because the engraving sensitivity is improved. Hereinafter, the polymer having such glass transition temperature is referred to as a non-elastomer. That is, the elastomer is generally defined scientifically as a polymer having a glass transition temperature that is no greater than normal temperature (20° C.) (see Kagaku Daijiten (comprehensive dictionary of science), P154, second edition, edited by Foundation for Advancement of International Science, published by Maruzen Co., Ltd.). Accordingly, the non-elastomer denotes polymers having a glass transition temperature that is greater than ordinary temperature. Although the upper limit of the glass transition temperature of the specific polymer is not particularly limited, it is preferably no greater than 200° C. from the viewpoint of handling properties, and more preferably at least 25° C. but no greater than 120° C.

When a polymer having a glass transition temperature of room temperature (20° C.) or greater is used, the specific polymer is in a glass state at normal temperature. Because of this, compared with a case of the rubber state, thermal molecular motion is suppressed. In laser engraving, in addition to the heat given by a laser during laser irradiation, heat generated by the function of a photothermal conversion agent added as desired is transmitted to the surrounding specific polymer, and this polymer is thermally decomposed and disappears, thereby forming an engraved recess.

When the specific polymer is used, it is surmised that when a photothermal conversion agent is present in a state in which thermal molecular motion of the specific polymer is suppressed, heat transfer to and thermal decomposition of the specific polymer occur effectively. It is anticipated that such an effect further increases the engraving sensitivity.

Examples of the binder that can be preferably used in the present invention are shown below.

### (1) Polyvinyl Acetal and Derivative Thereof

Polyvinyl acetal is a compound obtained by converting polyvinyl alcohol (obtained by saponifying polyvinyl acetate) into a cyclic acetal. A polyvinyl acetal derivative is a polymer that polyvinyl acetal is modified, or a polyvinyl acetal having another copolymerization component.

The acetal content in the polyvinyl acetal (mole % of vinyl alcohol units converted into acetal with the total number of moles of vinyl acetate monomer starting material as 100%) is preferably 30 to 90%, more preferably 50 to 85%, and particularly preferably 55 to 78%.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal derivative may further have another copolymerization unit.

Examples of the polyvinyl acetal include polyvinyl butyral, polyvinyl propylal, polyvinyl ethylal, and polyvinyl methylal. Among them, polyvinyl butyral (PVB) is preferable.

Polyvinyl butyral is a polymer obtained by a reaction polyvinyl alcohol and butyl aldehyde. A polyvinyl butyral derivative may be used.

Examples of the polyvinyl butyral derivatives include an acid-modified PVB in which at least some of the hydroxy groups of the hydroxyethylene units are modified with an acid group such as a carboxy group, a modified PVB in which some of the hydroxy groups are modified with a (meth)acryloyl group, a modified PVB in which at least some of the hydroxy groups are modified with an amino group, and a modified PVB in which at least some of the hydroxy groups have introduced thereinto ethylene glycol, propylene glycol, or a multimer thereof.

From the viewpoint of a balance being achieved between engraving sensitivity and film formation properties, the molecular weight of the polyvinyl acetal is preferably 5,000 to 800,000 as the weight-average molecular weight, more preferably 8,000 to 500,000 and, from the viewpoint of improvement of rinsing properties for engraving residue, particularly preferably 50,000 to 300,000.

Particularly preferable examples of the polyvinyl acetal are explained below by polyvinyl butyral (PVB) and the derivatives thereof, but the polyvinyl acetal should not be construed as being limited to the Examples.

Polyvinyl butyral derivatives are commercially available and preferable examples from viewpoint of solubility in alcohol, particularly in ethanol, are the ‘E-LEC B’ series and the ‘E-LEC K (KS)’ series manufactured by Sekisui Chemical co., Ltd., the Denka Butyral series manufactured by Denki Kagaku Kogyo Kabushiki Kaisha. From the viewpoint of alcohol solubility (particularly in ethanol), the polyvinyl butyral is preferably the ‘S-LEC B’ series and the ‘S-LEC K(KS)’ series manufactured by Sekisui Chemical Co., Ltd. From the viewpoint of alcohol solubility (particularly in ethanol), the ‘S-LEC B’ series manufactured by Sekisui Chemical Co., Ltd. and ‘Denka Butyral’ manufactured by Denki Kagaku Kogyo Kabushiki Kaisha are more preferable; among the ‘S-LEC B’ series, ‘BL-1’, ‘BL-1H’, ‘BL-2’, ‘BL-5’, ‘BL-S’, ‘BX-L’, ‘BM-S’, and ‘BH-S’ are particularly preferable, and among the ‘Denka Butyral’ manufactured by Denki Kagaku Kogyo Kabushiki Kaisha ‘#3000-1’, ‘#3000-2’, ‘#3000-4’, ‘#4000-2’, ‘#6000-C’, ‘#6000-EP’, ‘#6000-CS’, and ‘#6000-AS’ are particularly preferable.

When manufacturing a thermally curable resin composition layer from PVB as the specific polymer, casting and drying of a solution in a solvent is preferable from viewpoint of flatness of the film surface.

In addition to the polyvinylacetal and derivatives thereof, as the specific polymer, it is also possible to use an acrylic resin that is obtained by using a known acrylic monomer and has a hydroxyl group in a molecule. Furthermore, as the specific polymer, a novolac resin that is a resin obtained by condensing phenols and aldehydes under an acidic condition may also be used. Moreover, as the specific polymer, an epoxy resin having a hydroxyl group on a side chain may also be used.

Among the specific polymers, polyvinyl butyral and derivatives thereof are particularly preferable from the viewpoint of rinsing properties and printing durability when made into a thermally cured layer.

The content of a hydroxyl group contained in the specific polymer in the present invention is preferably 0.1 to 15 mmol/g, and more preferably 0.5 to 7 mmol/g, in the polymer of any embodiment described above.

With regard to the binder in the resin composition, only one type may be used or two or more types may be used in combination.

The weight average molecular weight of the binder that can be used in the present invention (on a polystyrene basis by GPC measurement) is preferably 5,000 to 1,000,000, more preferably 8,000 to 750,000, and most preferably 10,000 to 500,000.

From the viewpoint of satisfying the shape retention, water resistance and engraving sensitivity of the coated film in a balanced manner, the content of the specific polymer in the resin composition employable in the present invention is, in the total solids content, preferably 2 to 95 wt %, more preferably 5 to 80 wt %, and particularly preferably 10 to 60 wt %.

The content of the binder polymer is preferably 5 to 95 wt % relative to a solids content basis total weight of the resin composition for laser engraving, more preferably 15 to 80 wt %, and yet more preferably 20 to 65 wt %.

For example, when the resin composition for laser engraving of the present invention is applied to the thermally cured layer of the relief printing plate precursor, setting the content of the binder polymer to at least 5 wt % gives printing durability that is sufficient for the relief printing plate so obtained to be used as a printing plate, and setting it to no greater than 95 wt % gives flexibility that is sufficient for the relief printing plate so obtained to be used as a flexographic printing plate, without making other components insufficient.

### Crosslinking Agent

From the viewpoint of forming a crosslinked structure in a thermally cured layer, the resin composition for laser engraving preferably contains a crosslinking in order to form this crosslinked structure.

In regard to the crosslinking agent that can be used in the present invention, any crosslinking agent can be used without particular limitations as long as it can be converted to a polymer by a light- or heat-induced chemical reaction and be cured. Particularly, a polymerizable compound having an ethylenically unsaturated group (hereinafter, also referred to as “polymerizable compound”), a reactive silane compound having a reactive silyl group such as an alkoxysilyl group or a halogenated silyl group, a reactive titanium compound, a reactive aluminum compound, or the like is preferably used, and a reactive silane compound is more preferably used. These compounds may form a crosslinked structure within the thermally cured layer by reacting with the binder, or may form a crosslinked structure by reacting with other polymerizable compounds. The polymerizable compounds may also form a crosslinked structure through both the reactions.

The polymerizable compound that can be used herein can be arbitrarily selected among compounds having at least one ethylenically unsaturated group, preferably two or more ethylenically unsaturated groups, and more preferably 2 to 6 ethylenically unsaturated groups.

The resin composition for laser engraving preferably contains a compound having a group represented by following Formula (I) (hereinafter, also referred to as “Compound (I)”).

-M(R¹)(R²)ₙ (I)

wherein in Formula (I), R¹ represents OR³ or a halogen atom; M represents Si, Ti or Al; when M is Si, n represents 2; when M is Ti, n represents 2; when M is Al, n represents 1; n units of R²s each independently represent a hydrocarbon group, OR³ or a halogen atom; and R³ represents a hydrogen atom or a hydrocarbon group.

In Formula (I), M represents Si, Ti or Al. Among these, M is preferably Si or Ti, and more preferably Si.

In Formula (I), R¹ represents OR³ or a halogen atom, and R³ represents a hydrogen atom or a hydrocarbon group. Examples of the hydrocarbon group include an alkyl group having 1 to 30 carbon atoms, an aryl group having 6 to 30 carbon atoms, an alkenyl group having 2 to 30 carbon atoms, and an aralkyl group having 7 to 37 carbon atoms. Among these, R³ is preferably a hydrogen atom, an alkyl group having 1 to 12 carbon atoms, or an aryl group having 6 to 20 carbon atoms; more preferably a hydrogen atom, an alkyl group having 1 to 5 carbon atoms, or an aryl group having 6 to 10 carbon atoms; and particularly preferably a methyl group or an ethyl group. That is, R¹ is particularly preferably a methoxy group or an ethoxy group.

R¹ is preferably a group capable of ionizing to -M(R²)ₙO⁻ when treated with an alkaline rinsing liquid.

In Formula (I), R² represents a hydrocarbon group, OR³ or a halogen atom. R³ has the same meaning as described above, and also has the same preferred range.

R² is preferably OR³ or a halogen atom, and more preferably OR³.

When M is Si, n is 2. When M is S¹, R²s that are present in a plural number may be respectively identical or different, and are not particularly limited.

Furthermore, when M is Ti, n is 2. When M is T¹, R²s that are present in a plural number may be respectively identical or different, and are not particularly limited.

When M is Al, n represents 1.

Compound (I) described above may be a compound which introduces a group represented by Formula (I) into a polymer through a reaction with the polymer, or may also be a compound which has a group represented by Formula (1) from before the reaction, and introduces the group represented by Formula (I) to the polymer.

Compound (I) described above is particularly preferably such that M is Si.

The thermally cured layer preferably has a siloxane bond.

When M is Si, a silane coupling agent can also be used as the compound having a group represented by Formula (I) (Compound (I)). Meanwhile, the silane coupling agent is a compound which has a group capable of reacting with an inorganic compound, such as an alkoxysilyl group, and a group capable of reacting with an organic component, such as a methacryloyl group, and can conjugate an inorganic component and an organic component. A titanium coupling agent and an aluminate-based coupling agent also have the same meanings.

It is also preferable that Compound (I) have a reactive group such as a vinyl group, an epoxy group, a methacryloyloxy group, an acryloyloxy group, a mercapto group, or an amino group, and react with a polymer by means of the reactive group, so that the group represented by Formula (I) is introduced into the polymer through this reaction.

Examples of the silane coupling agent include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-chloropropyltrimethoxysilane, and γ-ureidopropyltriethoxysilane.

As Compound (I), a compound having plural groups represented by Formula (I) is also preferably used. In this case, when a portion of the groups represented by Formula (I) reacts with a polymer, the groups represented by Formula (I) can be introduced into the polymer. For example, R¹ group and optionally R² group of compound (I) react with an atom and/or a group in the polymer, which are capable of reacting with the compound (for example, a hydroxyl group (—OH)) (for example, an alcohol exchange reaction). Furthermore, when plural groups represented by Formula (I) are bonded to the polymer, Compound (I) also functions with a crosslinking agent, and can form a crosslinked structure.

Such Compound (I) is preferably a compound having plural groups represented by Formula (I), more preferably a compound having 2 to 6 groups represented by Formula (I), and particularly preferably a compound having 2 to 3 groups represented by Formula (I).

The compounds shown below may be mentioned as preferred examples, but the present invention is not limited to these compounds.

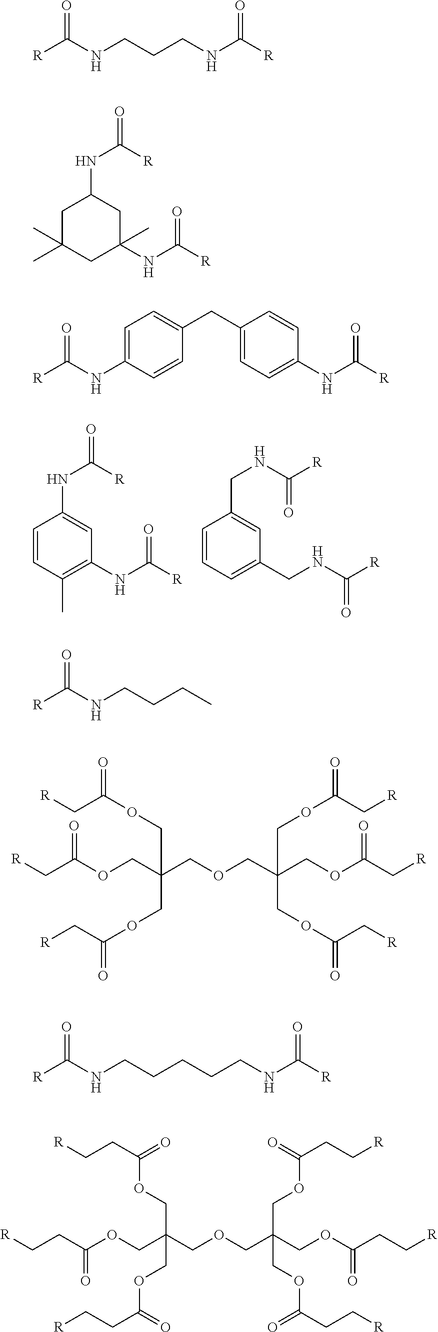

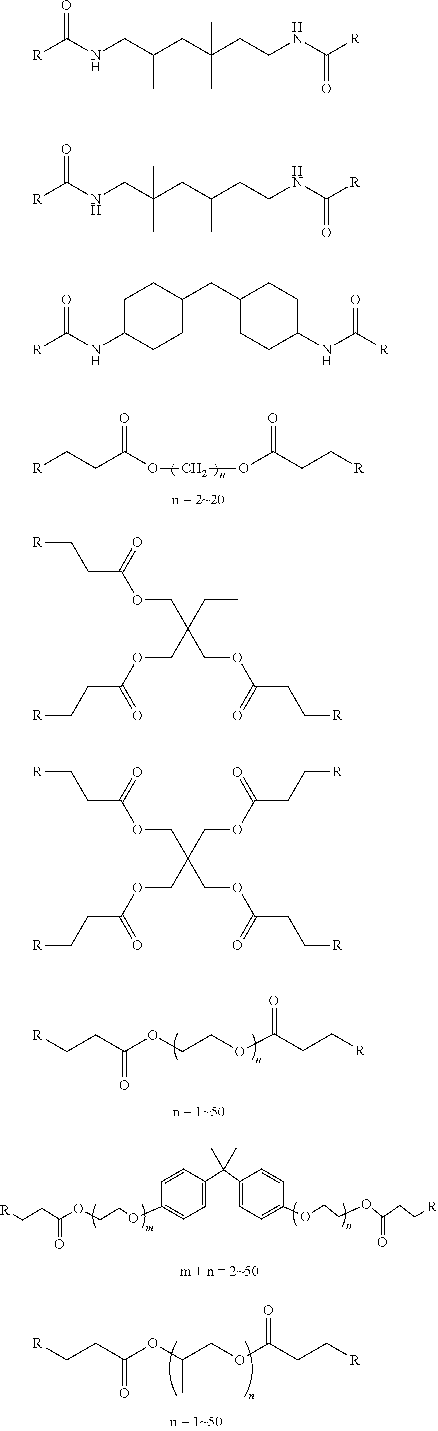

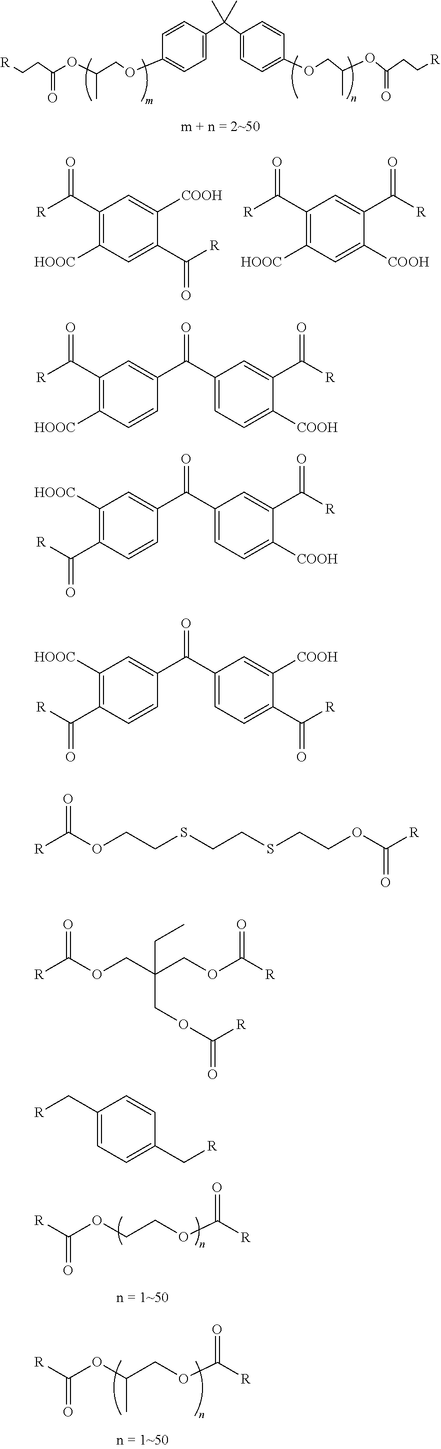

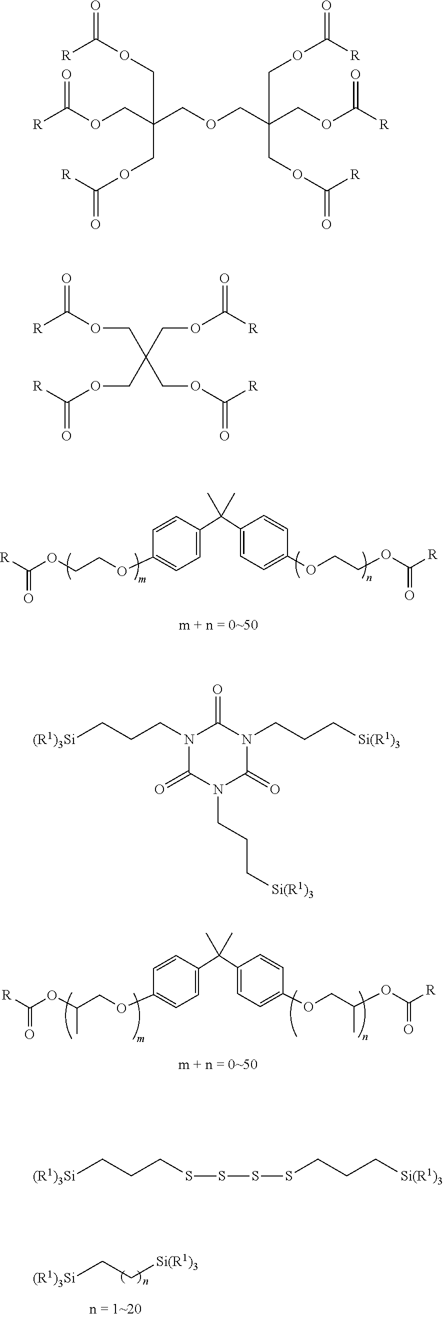

In each of the formulae above, R denotes a partial structure selected from the structures below. When a plurality of Rs and R¹s are present in the molecule, they may be identical to or different from each other, and are preferably identical to each other in terms of synthetic suitability.

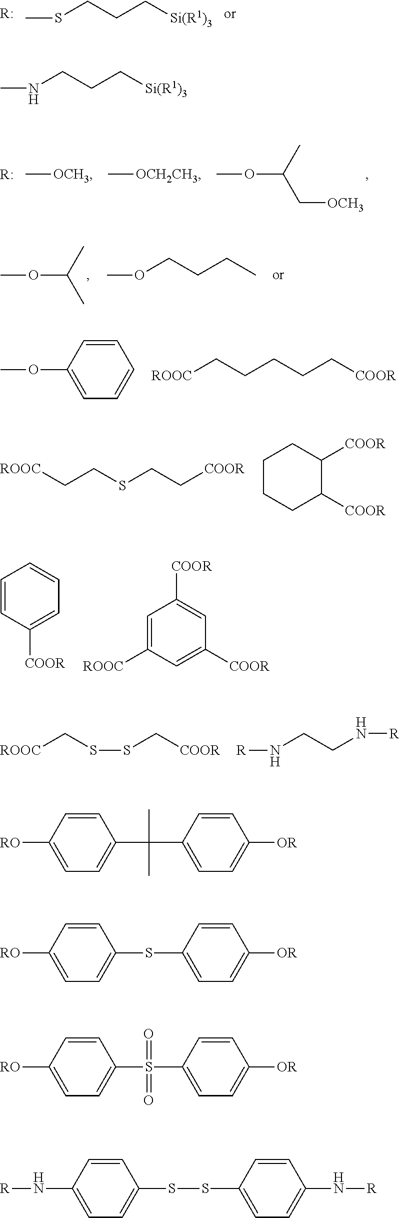

In each of the formulae above, R denotes a partial structure shown below. R¹ is the same as defined above. When a plurality of Rs and R¹s are present in the molecule, they may be identical to or different from each other, and in terms of synthetic suitability are preferably identical to each other.

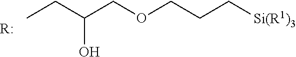

Furthermore, according to the present invention, silica particles, titanium oxide particles, aluminum oxide particles and the like can also be used as Compound (I) described above. These particles can react with a polymer that will be described below, and the group represented by Formula (I) can be introduced into the polymer. For example, when silica particles react with a polymer that will be described below, an —SiOH group is introduced.

In addition to that, examples of the titanium coupling agent include Plenact manufactured by Ajinomoto Fine Techno Co., Inc., titanium tetraisopropoxide manufactured by Matsumoto Fine Chemical Co., Ltd., and titanium-i-propoxybis(acetylacetonato)titanium manufactured by Nippon Soda Co., Ltd., and examples of the aluminate-based coupling agent include acetoalkoxy aluminum diisopropylate.

In the present invention, the compound (1) may be used only one type or two or more types in combination.

The total content of the compound (1) contained in the resin composition for laser engraving is preferably in the range of 0.1 to 80 wt % on a solids content basis, more preferably in the range of 1 to 40 wt %, and yet more preferably in the range of 5 to 30 wt %.

According to the present invention, from the viewpoint of forming a crosslinked structure in the thermally cured layer, the resin composition for laser engraving preferably contains a polymerizable compound in order to form this structure.

The polymerizable compound that can be used herein can be selected freely among compounds having at least one ethylenically unsaturated group, preferably two or more ethylenically unsaturated groups, and more preferably 2 to 6 ethylenically unsaturated groups.

Furthermore, according to the present invention, from the viewpoint of film properties such as flexibility and brittleness in addition to the purpose of forming a crosslinked structure, a compound having only one ethylenically unsaturated group (a monofunctional polymerizable compound, a monofunctional monomer) may also be used.

Hereinafter, a compound having one ethylenically unsaturated group (a monofunctional monomer), and a compound having two or more ethylenically unsaturated groups (a polyfunctional monomer) employed as the polymerizable compound are explained.

In the thermally curable layer, polyfunctional monomers are preferably used, because the thermally cured layer preferably has a crosslinked structure. The polyfunctional monomer has preferably a molecular weight of 200 to 2,000.

Examples of the monofunctional monomers include esters of an unsaturated carboxylic acid (such as acrylic acid, methacrylic acid, itaconic acid, crotonic acid, isocrotonic acid or maleic acid) with a monovalent alcohol compound, amides of an unsaturated carboxylic acid with a monovalent amine compound, etc. Examples of the polyfunctional monomers include esters of an unsaturated carboxylic acid (such as acrylic acid, methacrylic acid, itaconic acid, crotonic acid, isocrotonic acid or maleic acid) with a polyvalent alcohol compound, amides of an unsaturated carboxylic acid with a polyvalent amine compound, etc.

From the viewpoint of improving engraving sensitivity, it is preferable in the present invention to use as the polymerizable compound having an ethylenically unsaturated group a compound having a sulfur atom in the molecule.

As such an ethylenically unsaturated compound having a sulfur atom in the molecule, it is preferable from the viewpoint of improving engraving sensitivity in particular to use a polymerizable compound having two or more ethylenically unsaturated bonds and having a carbon-sulfur bond at a site where two ethylenically unsaturated bonds among them are linked (hereinafter, called a ‘sulfur-containing polyfunctional monomer’ as appropriate).

Examples of carbon-sulfur bond-containing functional groups of the sulfur-containing polyfunctional monomer in the present invention include sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea-containing functional groups.

Furthermore, a linking group containing a carbon-sulfur bond linking two ethylenically unsaturated bonds of the sulfur-containing polyfunctional monomer is preferably at least one unit selected from —C—S—, —C—S—S—, —NHC(═S)O—, —NHC(═O)S—, —NHC(═S)S—, and —C—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the molecule is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional polymerizable compound or monofunctional polymerizable compound having no sulfur atom in the molecule.

From the viewpoint of engraving sensitivity, a mode in which a sulfur-containing polyfunctional monomer is used on its own or a mixture of a sulfur-containing polyfunctional monomer and a monofunctional ethylenic monomer is used is preferable, and a mode in which a mixture of a sulfur-containing polyfunctional monomer and a monofunctional ethylenic monomer is used is more preferable.

In the thermally cured layer, when a polymerizable compound including a sulfur-containing polyfunctional monomer is used, the film properties, for example, brittleness and flexibility, can be adjusted.

Furthermore, the total content of the polymerizable compound including a sulfur-containing polyfunctional monomer in the resin composition is preferably 10 to 60 wt %, and more preferably 15 to 45 wt %, with respect to the non-volatile components, from the viewpoint of flexibility and brittleness of the crosslinked film.

When a polymerizable compound that is different from the sulfur-containing polyfunctional monomer is used in combination, the amount of the sulfur-containing polyfunctional monomer in the total amount of polymerizable compounds is preferably 5 wt % or more, and more preferably 10 wt % or more.

### Solvent

The resin composition for laser engraving that can be used in the present invention preferably contains a solvent in order to easily form a thermally curable resin composition layer.

According to the present invention, for the solvent used to prepare the resin composition, it is preferable to use mainly an aprotic organic solvent from the viewpoint of rapidly carrying out a reaction between Compound (I) and a specific polymer. More specifically, it is preferable to use an aprotic organic solvent/protic organic solvent=100/0 to 50/50 (weight ratio). The weight ratio is more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methly isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

The solvent is preferably removed from the thermally curable resin composition layer formed from the resin composition for laser engraving before the resin composition layer is cured by heat.

The method for removing the solvent is not particularly limited, and can be carried out by a known method.

### Alcohol Exchange Reaction Catalyst

The resin composition preferably comprises an alcohol exchange reaction catalyst in order to promote reaction the compound (I) and the specific binder polymer, in using the compound (I) for the resin composition.

With regard to the alcohol exchange reaction catalyst, any reaction catalyst that is usually used in a silane coupling reaction may be used without any limitation.

An acidic catalyst, a basic catalyst, and a metal complex catalyst, which are representative alcohol exchange reaction catalysts, are individually explained below.

### “An Acidic or a Basic Catalyst”

As the catalyst, an acidic or basic catalyst is used as it is or in the form of a solution in which it is dissolved in a solvent such as water or an organic solvent. The concentration when dissolved in a solvent is not particularly limited, and it may be selected appropriately according to the properties of the acidic or basic compound used, desired catalyst content, etc.

The type of the alcohol exchange reaction catalyst is not limited, and examples of the acidic catalyst include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, heteropoly acid, inorganic solid acid etc, and examples of the basic catalyst include an ammoniacal base such as aqueous ammonia, an amine such as ethyl amine and aniline etc. Among these, from the viewpoint of progressing fastly an alcohol exchange reaction in the layer, methanesulfonic acid, p-toluenesulfonic acid, pyridinium-p-toluene sulfonate, phosphoric acid, phosphonic acid and acetic acid are preferable, and methanesulfonic acid, p-toluenesulfonic acid and phosphoric acid are particularly preferable.

### “Metal Complex Catalyst”

The metal complex catalyst that can be used as an alcohol exchange reaction catalyst in the present invention is preferably constituted from a metal element selected from Groups 2, 4, 5, and 13 of the periodic table and an oxo or hydroxy oxygen compound selected from β-diketones, ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti is excellent and preferable, ethyl orthotitanate, etc. is more preferable.

These metal complex catalysts are excellent in terms of stability in an aqueous coating solution and an effect in promoting gelling in a sol-gel reaction when thermally drying, and among them, ethyl acetoacetate aluminum diisopropylate, aluminum tris(ethyl acetoacetate), a di(acetylacetonato)titanium complex salt, and zirconium tris(ethyl acetoacetate) are particularly preferable.

The resin composition of the present invention may employ only one type of an alcohol exchange reaction catalyst or two or more types thereof in combination.

The content of the alcohol exchange reaction catalyst in the resin composition is preferably 0.01 to 20 weight % in the content of the polymer having a hydroxy group, and more preferably 0.1 to 10 weight %.

### Polymerization Initiator

The resin composition for laser engraving that can be used in the present invention preferably comprises a polymerization initiator, and more preferably comprises a polyfunctional ethylenically unsaturated compound and a polymerization initiator in order to promote formation of the crosslinked structure.

With regard to the polymerization initiator, one known to a person skilled in the art may be used without any limitations. Radical polymerization initiators, which are preferred polymerization initiators, are explained in detail below, but the present invention should not be construed as being limited to these descriptions.

Polymerization initiators can be roughly divided into photopolymerization initiators and thermopolymerization initiators.

As the photopolymerization initiator, those described above is preferably used.

In the present invention, from the viewpoint of increasing the degree of crosslinking, a thermopolymerization initiator is preferably used.

As the thermopolymerization initiator, an organic peroxide (c) and an azo-based compound (I) are preferably used. The compounds shown below are particularly preferable.

### (c) Organic Peroxide

Preferable examples of the organic peroxide (c) as the radical polymerization initiator that can be used in the present invention include prederably ether peoxide such as 3,3′,4,4′-tetra(tertiarybutylperoxycarbonyl)benzophenone, 3,3′,4,4′-tetra(tertiaryamylperoxycarbonyl)benzophenone, 3,3′,4,4′-tetra(tertiaryhexylperoxycarbonyl)benzophenone, 3,3′,4,4′-tetra(tertiaryoctylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-tertiarybutyldiperoxy isophthalate etc.

### (I) Azo-Based Compound

Preferred examples of the azo-based compound (I) that can be used in the present invention include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), 2,2′-dimethyl azobisisobutyrate, 2,2′-azobis(2-methylpropionamidoxime), 2,2′-azobis[2-(2-imidazoline-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane), etc.

With regard to the polymerization initiator in the present invention, one type may be used on its own or two or more types may be used in combination.

The content of the polymerization initiator is preferably 0.01 to 10 weight % in the total solids content of the resin composition for laser engraving, and more preferably 0.1 to 3 weight %.

### Photothermal Conversion Agent

The thermally cured layer preferably comprises a photothermal conversion agent.

The resin composition for laser engraving preferably comprises a photothermal conversion agent.

That is, It is surmised that the photothermal conversion agent in the present invention absorbs laser light and generates heat thus promoting thermal decomposition of a cured material of the resin composition for laser engraving of the present invention. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the relief-forming layer in the present invention to comprise a photothermal conversion agent that can absorb light having a wavelength of 700 to 1,300 nm.

As the photothermal conversion agent in the present invention, various types of dye or pigment are used.

The photothermal conversion agent is more preferably at least one photothermal conversion agent selected from the group consisting of a pigment and a dye having a maximum absorption wavelength at 800 to 1,200 nm.

The photothermal conversion agent is preferably a pigment.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium dyes, pyrylium salts, and metal thiolate complexes. In particular, cyanine-based dyes such as heptamethine cyanine dyes, oxonol-based dyes such as pentamethine oxonol dyes, and phthalocyanine-based dyes are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low DBP absorption and also finely divided carbon black having a large specific surface area. Preferred examples of carbon black include Printex (registered trademark) U, Printex (registered trademark) A, and Spezialschwarz (registered trademark) 4 (Degussa).

The carbon black that can be used in the present invention is preferably a conductive carbon black having a specific surface area of at least 150 m²/g and a dibutyl phthalate (DBP) absorption number of at least 150 mL/100 g.

From the viewpoint of improving engraving sensitivity by efficiently transmitting heat generated by photothermal conversion to the surrounding polymer, etc., the carbon black is preferably a conductive carbon black having a specific surface area of at least 150 m²/g.

The content of the photothermal conversion agent in the thermally cured layer or the resin composition for laser engraving of the present invention largely depends on the size of the molecular extinction coefficient characteristic to the molecule, and is preferably 0.01 to 20 wt % relative to the total weight of the solids content of the thermally cured layer or the resin composition, more preferably 0.05 to 10 wt %, and yet more preferably 0.1 to 5 wt %.

### Other Additives

The resin composition for laser engraving and the thermally cured layer of the relief printing plate precursor may be comprise a known additive other than those described above.

The resin composition for laser engraving of the present invention contains preferably a plasticizer.

The plasticizer is a material having the function of softening the film formed with the resin composition for laser engraving, and has necessarily a good compatibility relative to the binder polymer.

As the plasticizer, for example, dioctyl phthalate, didodecyl phthalate, polyethylene glycols, and polypropylene glycols (such as monool type and diol type) are used preferably.

The resin composition for laser engraving of the present invention preferably comprises, as an additive for improving engraving sensitivity, nitrocellulose or a high thermal conductivity material. Since nitrocellulose is a self-reactive compound, it generates heat during laser engraving, thus assisting thermal decomposition of a coexisting binder polymer such as a hydrophilic polymer. It is surmised that as a result, the engraving sensitivity improves. A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer or a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition.

For the purpose of coloring the resin composition for laser engraving, a colorant such as a dye or a pigment may be added. This enables properties such as visibility of an image area or suitability for an image densitometer to improve.

Furthermore, in order to improve physical properties of the thermally cured layer, a known additive such as a filler may be added.

### (Method for Producing Relief Printing Plate Precursor for Laser Engraving)

The method for producing a relief printing plate precursor for laser engraving (hereinafter, also simply referred to as “relief printing plate precursor”) of the present invention is not particularly limited as long as the relief printing plate precursor for laser engraving of the present invention can be produced. However, the method is preferably a production method including a layer forming step of forming a thermally curable layer on a substrate; a thermal curing step of thermally curing the thermally curable layer to form a thermally cured layer; a preparation step of preparing a photocurable composition containing (Component A) an ethylenically unsaturated compound, (Component B) a photopolymerization initiator, and (Component C) particles having a diameter of 5 to 100 μm; a bonding step of applying the photocurable composition and bonding the thermally cured layer or the thermally curable layer and a support; and a photocuring step of curing the photocurable composition by light to form a photocured layer and adhering the thermally curable layer or the thermally cured layer and the support.

Hereinafter, the method for producing a relief printing plate precursor for laser engraving of the present invention will be described in detail.

### <Layer Forming Step>

The method for producing a relief printing plate precursor of the present invention preferably includes a layer forming step of forming a thermally curable layer on a substrate.

The substrate for the layer forming step is not particularly limited, and any known substrate can be used.

The shape of the substrate may be a sheet-like shape, a belt-like shape or a plate-like shape, and is not particularly limited, but the shape is preferably a belt-like shape. The material of the substrate is also not particularly limited, and any known material such as a resin, a rubber, or a metal may be used.

In the layer forming step, the substrate and the thermally curable layer may be in direct contact or may not be in direct contact, for example, having another layer such as a protective layer between the substrate and the thermally curable layer; however, it is preferable that the substrate and the thermally curable layer be in direct contact. When the substrate and the thermally curable layer are in direct contact, the image-drawn surface of the thermally curable layer can be converted to a desired surface shape in accordance with the surface shape of the substrate, if necessary.

Furthermore, when the substrate is in direct contact with the thermally curable layer, it is preferable that the surface of the substrate on the side that is in contact with the thermally curable layer be smooth.

The thermally curable layer is not particularly limited, and any known layer can be used. However, the thermally curable layer is particularly a layer formed from the resin composition for laser engraving.

In the layer forming step, the method for forming a thermally curable layer on a substrate is not particularly limited, but preferred examples include a method of preparing a resin composition for laser engraving, removing the solvent from this resin composition for relief engraving as necessary, and then melt extruding the resin composition on the substrate; and a method of flow casting the resin composition on the substrate, removing at least a portion of the solvent in the resin composition, and forming a thermally curable layer. A method of flow casting the resin composition on the substrate, removing at least a portion of the solvent in the resin composition, and forming a thermally curable layer is more preferably used.

The resin composition for laser engraving can be prepared by, for example, dissolving a crosslinking agent, a binder polymer, and a photothermal conversion agent, a fragrance, and a plasticizer as optional components in an appropriate solvent. Since most of the solvent component needs to be removed in the stage of producing a relief printing plate precursor, it is preferable to use a low molecular weight alcohol that is easily volatilzed (for example, methanol, ethanol, n-propanol, isopropanol, or propylene glycol monomethyl ether) or the like as the solvent, and to decrease the total amount of the solvent added to the minimum by adjusting the temperature or the like.

### <Thermal Curing Step>

The method for producing a relief printing plate precursor of the present invention preferably includes a thermal curing step of thermally curing the thermally curable layer and forming a thermally cured layer.

The thermal curing step may be carried out before the bonding step, or may be after the bonding step, but it is preferable to carry out the thermal curing step before the bonding step.

Furthermore, the thermally cured layer in the relief printing plate precursor of the present invention preferably has a crosslinked structure from the viewpoint of the laser engraving properties, and more preferably has a crosslinked structure in the stage before the bonding step, by carrying out the thermal curing step before the bonding step. When the thermally cured layer has a crosslinked structure, there are advantages that, firstly, the relief formed after laser engraving becomes sharp, and secondly, the adhesiveness of the engraving residue generated at the time of laser engraving is suppressed.

The heating means for carrying out curing by heat is not particularly limited, and curing may be carried out by applying heat by a known method. However, for example, a method of heating the thermally curable layer in a hot air oven or a far-infrared oven for a predetermined time, or a method of bringing the thermally curable layer into contact with a heated roller for a predetermined time, may be used.

Furthermore, in regard to the curing, not only curing by heat, but also curing by light may be further carried out.

The curing by light may be carried out before curing by heat, simultaneously with curing by heat, or after curing by heat.

Examples of the light include visible light, ultraviolet light, or electron beam, but ultraviolet light is most preferable. Furthermore, irradiation of light is preferably carried out over the entire surface of the thermally curable layer or the thermally cured layer. In the crosslinking by light, when the support side of the thermally curable layer or the thermally cured layer is designated as a back surface, it is sufficient to irradiate only the front surface with light. However, if the support is a transparent film transmitting light, it is preferable to further irradiate light through the back surface. Irradiation from the front surface may be carried out, in the case where a protective film is present, while this protective film is provided, or may be carried out after peeling off the protective film. When there is a risk that the crosslinking reaction may be inhibited in the presence of oxygen, the thermally curable layer or the thermally cured layer may be covered with a vinyl chloride sheet, a vacuum is drawn, and then irradiation of light may be carried out. Furthermore, the irradiation of light can be carried out using a known light source.

### <Preparation Step>

The method for producing a relief printing plate precursor of the present invention preferably includes a preparation step of preparing a photocurable composition containing (Component A) an ethylenically unsaturated compound, (Component B) a photopolymerization initiator, and (Component C) particles having a diameter of 5 to 100 μm.

A photocurable composition containing Component A to Component C has the same meaning as the photocurable composition in connection with the relief printing plate precursor of the present invention described above, and preferred embodiments are also the same.

Furthermore, the photocurable composition is not particularly limited, and can be prepared by a known mixing method. Specifically, for example, a method of mixing Component A to Component C and other components all at once, or a method of mixing Component A, Component C and other components, and then mixing Component B, may be used.

### <Bonding Step>

The method for producing a relief printing plate precursor for laser engraving of the present invention preferably includes a bonding step of applying the photocurable composition and bonding the thermally curable layer or the thermally cured layer with a support.

In the bonding step, it is preferable to apply the photocurable composition on the surface opposite to the surface of the thermally cured layer or the thermally curable layer on the substrate side, that is, the air surface. When the embodiment described above is adopted, a relief printing plate precursor having excellent adhesiveness and film thickness uniformity is obtained.

The method of applying the photocurable composition on the thermally cured layer or the thermally curable layer in the bonding step is not particularly limited, and can be carried out by any known method.

Furthermore, the method of bonding the thermally cured layer or the thermally curable layer and a support in the bonding step is not particularly limited, and can be carried out by any known method.

### <Photocuring Step>

The method for producing a relief printing plate precursor for laser engraving of the present invention preferably includes a photocuring step of curing the photocurable composition by light to form a photocured layer, and adhering the photocurable layer or the thermally cured layer with the support.

The light used in the photocuring step is an active light ray capable of curing the photocurable composition by irradiation thereof. There are no particular limitations as long as the light is different from laser light capable of engraving a relief printing plate precursor, and the light includes α-rays, γ-rays, X-rays, ultraviolet rays (UV), visible rays, electron beam, and the like. Among them, it is particularly preferable to use ultraviolet rays as the light.

The laser light is a light having high corehence, and has excellent directionality or convergence properties. Examples include infrared laser light that will be described below.

Furthermore, the light used in the photocuring step is preferably a light having a wavelength of 200 to 600 nm.

The light source that can be used in the photocuring step is not particularly limited, but preferred examples include a mercury lamp and a metal halide lamp.

The amount of exposure of light in the photocuring step may be an amount capable of curing the photocurable composition, but the amount is preferably 10 to 4,000 mJ/cm², and more preferably 20 to 2,500 mJ/cm².

From the viewpoint of ease of curing by light, at least a portion of the support and the thermally curable layer or the thermally cured layer is preferably transparent, and it is more preferable that the support be a transparent support.

For the relief printing plate precursor, the peeling force between the thermally cured layer and the support is preferably 2 N/cm or more, more preferably 3 N/cm or more, and even more preferably 4 N/cm or more. Furthermore, the peeling force is preferably 20 N/cm or less.

Furthermore, the method for producing a relief printing plate precursor of the present invention may have a protection step of forming a peelable protective layer on the surface of the thermally curable layer or the thermally cured layer on the substrate side, as necessary. Examples of the method for providing a protective layer include a method of pressing a protective film and the thermally curable layer or the thermally cured layer with a heated calender roller or the like, and a method of closely adhering a protective layer to the thermally curable layer or the thermally cured layer, which has been impregnated with a small amount of a solvent on the surface.

In the case of using a protective film, a method of first providing a protective film on a substrate and laminating a thermally curable layer on the protective film in the layer forming step may also be employed.

Furthermore, when the protective is not peelable, or on the contrary, when the protective film does not easily adhere to the thermally curable layer or the thermally cured layer, a slip coat layer may be provided between the two layers. For the material used in the slip coat layer, it is preferable to use, as a main ingredient, a resin which can be dissolved or dispersed in water and has less adhesiveness, such as polyvinyl alcohol, polyvinyl acetate, partially saponified polyvinyl alcohol, hydroxyalkyl cellulose, alkyl cellulose, or a polyamide resin.

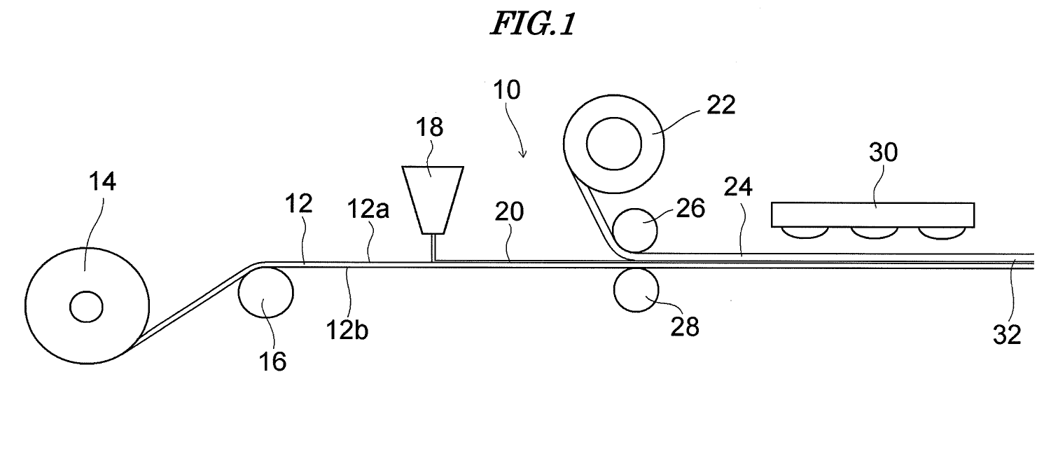

The production apparatus that is suitably used in the method for producing a relief printing plate precursor of the present invention is not particularly limited, but for example, an apparatus such as shown in FIG. 1 may be mentioned.

FIG. 1 is a schematic diagram showing an example of the production apparatus used in the method for producing a relief printing plate precursor of the present invention.

Thermally cured layer 12 formed by thermally curing a thermally curable layer (not illustrared) on a substrate, is wound around thermally cured layer roller 14 (not illustrated), and in production apparatus for relief printing plate precursor 10, thermally cured layer 12 is conveyed from thermally cured layer roller 14 using conveyance means 16 or the like. During conveyance, the upper surface of thermally cured layer 12 is taken as the surface facing the surface on the side of substrate (air surface) 12a, and the lower surface of thermally cured layer 12 is taken as the surface on substrate side 12b.

Conveyed thermally cured layer 12 is applied on air surface 12a with a photocurable adhesive by means of adhesive applicator 18, and thus photocurable layer 20 is formed.

Furthermore, thermally cured layer 12 on which photocurable layer 20 has been formed, is bonded with support 24 conveyed from support roller 22, by means of nip rollers 26 and 28.

Thermally cured layer 12 bonded with support 24 is irradiated with ultraviolet radiation from the side of support 24 by means of ultraviolet irradiation means 30, and photocurable layer 20 is cured and adhered. Thus, relief printing plate precursor 32 is obtained.

### (Relief Printing Plate and Process for Making Same)

The process for making a relief printing plate of the present invention comprises an engraving step of laser-engraving the relief printing plate precursor having the thermally cured layer.

The relief printing plate of the present invention is a relief printing plate having a relief layer obtained by laser-engraving the thermally cured layer of the relief printing plate precursor of the present invention.

### <Engraving Step>

The process for making a relief printing plate of the present invention comprises an engraving step of laser-engraving the relief printing plate precursor having the thermally cured layer.

The engraving step is a step of laser-engraving the thermally cured layer to thus form a relief layer. Specifically, it is preferable to engrave the thermally cured layer by irradiation with laser light according to a desired image, thus forming a relief layer. Furthermore, a step in which the thermally cured layer is subjected to scanning irradiation by controlling a laser head using a computer in accordance with digital data of a desired image can preferably be cited.

This engraving step preferably employs an infrared laser. When irradiated with an infrared laser, molecules in the thermally cured layer undergo molecular vibration, thus generating heat. When a high power laser such as a carbon dioxide laser or a YAG laser is used as the infrared laser, a large quantity of heat is generated in the laser-irradiated area, and molecules in the thermally cured layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the thermally cured layer at higher sensitivity, thus giving a relief layer having a sharp image.

As the infrared laser used in the engraving step, from the viewpoint of productivity, cost, etc., a carbon dioxide laser or a semiconductor laser is preferable. In particular, a fiber-coupled semiconductor infrared laser is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate producing equipment comprising a fiber-coupled semiconductor laser that can be used suitably in the process for producing a relief printing plate employing the relief printing plate precursor of the present invention, those described in detail in JP-A-2009-172658 and JP-A-2009-214334 can be cited. Such equipment comprising a fiber-coupled semiconductor laser can be used to produce a relief printing plate of the present invention.

The process for producing a relief printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13, and yet more preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a relief printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound. In the present invention, the structures of N═O of an amine oxide compound and P═O of a phosphine oxide compound are considered to be N⁺—O⁻and P⁺—O⁻ respectively.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The relief printing plate of the present invention having a relief layer may be produced as described above.

From the viewpoint of satisfying suitability for various aspects of flexographic printing, such as abrasion resistance and ink transfer properties, the thickness of the relief layer of the relief printing plate is preferably at least 0.05 mm but no greater than 10 mm, more preferably at least 0.05 mm but no greater than 7 mm, and yet more preferably at least 0.05 mm but no greater than 0.3 mm.

Furthermore, the Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The relief printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink. The relief printing plate of the present invention has excellent rinsing properties, there is no engraving residue, since a relief layer obtained has excellent elasticity aqueous ink transfer properties and printing durability are excellent, and printing can be carried out for a long period of time without plastic deformation of the relief layer or degradation of printing durability.

According to the present invention, a relief printing plate precursor for laser engraving, which is inexpensive and has excellent resolution power and ink transfer properties, a method for producing the printing plate precursor, a relief printing plate using the relief printing plate precursor for laser engraving, and a method for making the printing plate can be provided.

### EXAMPLES

The present invention is explained in further detail below by reference to Examples, but the present invention should not be construed as being limited to these Examples.

### Examples 1 to 7 and Comparative Examples 1 to 3

### Preparation of Photocurable Composition

Components were mixed in the following use amounts, and a photocurable composition used in various Examples and Comparative Examples was prepared.

| | |
|---|---|
| 2-Hydroxypropyl acrylate (manufactured by Osaka | 46 parts by weight |
| Organic Chemical Industry, Ltd.) | |
| Trimethylolpropane triacrylate (manufactured by | 35 parts by weight |
| Shin Nakamura Chemical Co., Ltd.) | |
| 1-Hydroxycyclohexyl phenyl ketone (manufactured | 8 parts by weight |
| by Ciba Specialty Chemicals, Inc.) | |
| Particles indicated in Table 1 | in amount indicated |
| | in Table 1 |

### <Preparation of Thermally Curable Recording Layer Composition>

In a three-necked flask equipped with a stirring blade and a cooling tube, 50 parts by weight of Gosenal T-215 (manufactured by Nippon Synthetic Chemical Industry Co., Ltd.; water-soluble PVA) as a specific polymer, and 47 parts by weight of propylene glycol monomethyl ether acetate as a solvent were introduced, and the mixture was heated for 120 minutes at 70° C. under stirring to thus dissolve the polymer. Subsequently, the solution was brought to 40° C., and 15 parts by weight of tributyl citrate as a plasticizer, 8 parts by weight of Blenmer LMA (manufactured by NOF Corp.) as a polymerizable compound (monofunctional compound), 1.6 parts by weight of Perbutyl Z (manufactured by NOF Corp.) as a polymerization initiator, and 1 part by weight of carbon black (Shoblack N110, manufactured by Cabot Japan K.K., DBP oil absorption 115 ml/100 g) as a photothermal conversion agent, were added to the solution. The mixture was stirred for 30 minutes. Thereafter, 15 parts by weight of Compound (I) (S-2) (the structure is shown below), and 0.4 parts by weight of phosphoric acid as a catalyst were added thereto, and the resulting mixture was stirred for 10 minutes at 40° C. Through this operation, a fluid coating liquid for relief-forming layer (thermally curable recording layer composition) was obtained.

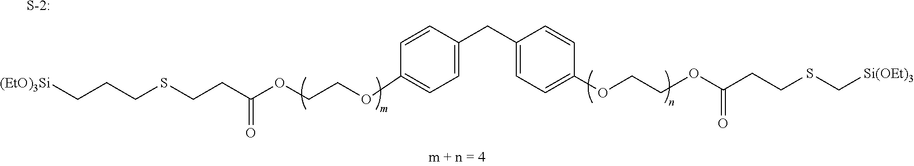

wherein Et represents an ethyl group.

### <Method for Producing Relief Printing Plate Precursor>

According to the formulations described in Table 1, various relief printing plate precursors were produced by the following operation.

A spacer (frame) having a predetermined thickness was provided on a PET substrate, and the coating liquid for relief-forming layer obtained as described above was gently flow cast so that the coating liquid would not flow out over the spacer (frame), and was dried for 3 hours in an oven at 90° C. A thermally curable layer having a thickness indicated in Table 1 was provided. Thus, a relief sheet was produced.

The recording layer of the relief sheet thus obtained was heated for 3 hours at 80° C. and further for 3 hours at 100° C., and the thermally curable layer was thermally crosslinked. Thus, a thermally cured layer was formed.

The photocurable composition was provided by coating under the conditions described in Table 1 on the relief sheet obtained by thermally crosslinking, and then a PET support having a thickness of 2.5 mm was bonded together with a nip roller. After 20 seconds, the photocurable layer was cured using a UV exposure machine (UV exposure machine ECS-151U manufactured by Eye Graphis Co., Ltd., a metal halide lamp, 1,500 mJ/cm², exposure for 14 sec) from the PET support side, and thereby, relief printing plate precursors were respectively produced. The elastic moduli, resolution powers and ink transfer properties of the respective relief printing plate precursors thus produced were respectively measured as follows. Furthermore, the cost used for each of the relief printing plate precursors thus produced was also evaluated by the following method. The evaluation results are summarized in Table 1.

### <Measurement of Elastic Moduli (Coefficients of Elasticity) of Photocured Layer and Thermally Cured Layer>

The measurement conditions for the storage modulus (E′) are shown below.

The measurement apparatus used for the dynamic viscoelasticity (DMA) was DMS6100 manufactured by SII NanoTechnology, Inc.

For the measurement conditions, a specimen having a width of 6 mm was held with a sample holder, and the measurement length was set at 10 mm. The thickness was measured separately. The specimen was subjected to heating from −30° C. to 50° C. at a rate of temperature increase of 4° C./min, and in the measurement in a tensile mode during this period, the dynamic viscoelasticity was measured at a maximum strain ratio of 0.1% and at 100 Hz. The difference between the temperature indicated by the thermocouple attached to the specimen and the temperature displayed by the apparatus was measured, and the temperature of the apparatus was calibrated. The storage modulus (E′) at 25° C. and at 100 Hz was determined.

### <Engraving Method>

As a semiconductor laser engraving machine, a laser recording apparatus equipped with a fiber-coupled semiconductor laser (FC-LD) SDL-6390 (manufactured by JDS Uniphase Corp., wavelength 915 nm) having a maximum output power of 8.0 W was used. A solid section which measured 1 cm on each side was raster engraved with a semiconductor laser engraving machine under the conditions of a laser output power of 7.5 W, a head speed of 409 mm/sec, and a pitch setting of 2400 DPI.

### <Rinsing Method>

A rinsing liquid was prepared by mixing water, a 10 wt % aqueous solution of sodium hydroxide, and a betaine compound (1-B) shown below, and adjusting the pH value to 12 and the content of Betaine Compound (1-B) to 1 mass % of the total amount of the rinsing liquid.

The rinsing liquid thus prepared was dropped (about 100 ml/m²) with dropper a on each of the printing plate material engraved by the method described above such that the plate surface would be uniformly wetted. After the printing plate was left to stand for one minute, the plate was rubbed horizontally using a toothbrush (Lion Corp., Clinica Toothbrush Flat) under a load of 200 gf for 20 times (30 seconds). Subsequently, the plate surface was washed with flowing water, water on the plate surface was removed, and the plate was naturally dried for about one hour.

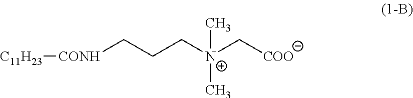

### (Evaluation)

### <Printing Method>

A relief printing plate thus obtained was mounted on a printing machine (ITM-4 type, manufactured by lyo Kikai Seishakusho co., Ltd.), and printing was performed using an aqueous ink Aqua SPZ16 Crimson (manufactured by Toyo Ink Group) as an ink without diluting, and using Full Color Form M 70 (manufactured by Nippon Paper Group, Inc., thickness 100 μm) as a printing paper.

### <Evaluation of Ink Transfer Properties>

A relief printing plate thus obtained was mounted on a printing machine (ITM-4 type, manufactured by lyo Kikai Seishakusho co., Ltd.), and printing was performed using an aqueous ink Aqua SPZ16 Crimson (manufactured by Toyo Ink Group) as an ink without diluting, and using Full Color Form M 70 (manufactured by Nippon Paper Group, Inc., thickness 100 μm) as a printing paper. The density of the printed paper was measured using a spectrophotometer, SpectroEye (manufactured by X-Rite, Inc.).

A sample having a density of 1.55 or higher was rated as “excellent”; a sample having a density of at least 1.45 but less than 1.55 as “good”; a sample having a density of at least 1.35 but less than 1.45 as “fair”; and a sample having a density of less than 1.35 as “poor”.

### <Evaluation of Resolution Power>

A half-dot pattern was formed by engraving 20 to 50 μm with 5-μm notches, and the minimum half-dot that was printed on paper when the half-dot pattern was printed by the printing method described above was evaluated.

### <Evaluation of Cost>

The material cost per unit weight was calculated based on the respective prices of the raw materials and the mixing ratios, and relative values with respect to the value of Comparative Example 3 are shown.

TABLE 1

| | | | Photocured layer | | | | | | | |
|---|---|---|---|---|---|---|---|---|---|---|
| | Thermally cured layer | | | Average | | | | | | |
| | Coefficient | | | particle | Amount of | | Coefficient | | | |
| | of | | | size of | particles | | of | | Ink | |
| | elasticity | Thickness | Type of | particles | added | Thickness | elasticity | Resolution | transfer | Cost |
| | E′ (MPa) | (μm) | particles | (μm) | (wt %) | (μm) | E′ (MPa) | power (μm) | properties | (%) |
| Example 1 | 13 | 700 | Silica Gel | 50 | 15 | 700 | 7 | 25 | good | −26 |
| | | | 60N | | | | | | | |
| Example 2 | 13 | 700 | Silica Gel | 50 | 30 | 700 | 9 | 20 | good | −39 |
| | | | 60N | | | | | | | |
| Example 3 | 13 | 700 | Silica Gel | 50 | 45 | 700 | 11 | 25 | good | −54 |
| | | | 60N | | | | | | | |
| Example 4 | 13 | 900 | Silica Gel | 50 | 30 | 500 | 7 | 20 | good | −22 |
| | | | 60N | | | | | | | |
| Example 5 | 13 | 500 | Silica Gel | 50 | 30 | 900 | 7 | 25 | good | −49 |
| | | | 60N | | | | | | | |
| Example 6 | 13 | 700 | Alumina | 5 | 30 | 700 | 9 | 25 | good | −52 |
| | | | A31 | | | | | | | |
| Example 7 | 13 | 700 | Alumina | 80 | 30 | 700 | 6 | 25 | good | −55 |
| | | | A21 | | | | | | | |
| Comparative | 13 | 500 | Silica Gel | 50 | 60 | 700 | 14 | 40 | poor | −62 |
| Example 1 | | | 60N | | | | | | | |
| Comparative | 13 | 700 | None | — | — | 700 | 2 | 30 | good | −8 |
| Example 2 | | | | | | | | | | |
| Comparative | 13 | 1,300 | None | — | — | 100 | 2 | 30 | fair | 0 |
| Example 3 | | | | | | | | | | |

The amount of particles added in Table 1 represents the content (wt %) relative to the total weight of the photocured layer. Furthermore, the average particle size of the particles in Table 1 represents the volume average particle size.

What is claimed is:

1. A relief printing plate precursor for laser engraving, comprising:
a photocured layer, and
a thermally cured layer,
on a support in this order,
the photocured layer being a layer obtained by photocuring a layer comprising (Component A) an ethylenically unsaturated compound, (Component B) a photopolymerization initiator, and (Component C) particles, and
the photocured layer and the thermally cured layer satisfying the relation of following Formula (I):
(Elastic modulus of the photocured layer)<(Elastic modulus of the thermally cured layer) (1)

2. The relief printing plate precursor for laser engraving according to claim 1, wherein Component A comprises a (meth)acrylate compound.

3. The relief printing plate precursor for laser engraving according to claim 1, wherein Component C is inorganic particles.

4. The relief printing plate precursor for laser engraving according to claim 1, wherein the thermally cured layer comprises a binder polymer and a photothermal conversion agent.

5. The relief printing plate precursor for laser engraving according to claim 4, wherein the photothermal conversion agent is a photothermal conversion agent capable of absorbing a light having a wavelength of 700 to 1,300 nm.

6. The relief printing plate precursor for laser engraving according to claim 4, wherein the photothermal conversion agent is carbon black.

7. The relief printing plate precursor for laser engraving according to claim 1, wherein the thermally cured layer is a layer obtained by thermally curing a layer containing a polymerizable compound.

8. A process for producing a relief printing plate precursor for laser engraving, the process comprising:
a laser forming step of forming a thermally curable layer on a substrate;
a thermal curing step of thermally curing the thermally curable layer and forming a thermally cured layer;
a preparation step of preparing a photocurable composition containing (Component A) an ethylenically unsaturated compound, (Component B) a photopolymerization initiator, and (Component C) particles having a diameter of 5 to 100 μm;
a bonding step of applying the photocurable composition and bonding the thermally curable layer or the thermally cured layer and a support; and
a photocuring step of curing the photocurable composition by light to form a photocured layer, and adhering the thermally curable layer or the thermally cured layer and the support,
the photocured layer and the thermally cured layer satisfying the relation of following Formula (I):
(Elastic modulus of the photocured layer)<(Elastic modulus of the thermally cured layer) (1)

9. The process for producing a relief printing plate precursor for laser engraving according to claim 8, wherein Component A comprises a (meth)acrylate compound.

10. The process for producing a relief printing plate precursor for laser engraving according to claim 8, wherein Component C is inorganic particles.

11. The process for producing a relief printing plate precursor for laser engraving according to claim 8, wherein curing is performed with a light having a wavelength of 200 to 600 nm in the photocuring step.

12. The process for producing a relief printing plate precursor for laser engraving according to claim 8, wherein the thermally cured layer comprises a binder polymer and a photothermal conversion agent.

13. The process for producing a relief printing plate precursor for laser engraving according to claim 12, wherein the photothermal conversion agent is a photothermal conversion agent capable of absorbing a light having a wavelength of 700 to 1,300 nm.

14. The process for producing a relief printing plate precursor for laser engraving according to claim 12, wherein the photothermal conversion agent is carbon black.

15. The process for producing a relief printing plate precursor for laser engraving according to claim 8, wherein the thermally curable layer comprises a polymerizable compound.

16. A process for making a relief printing plate, the process comprising:
an engraving step of laser engraving the thermally cured layer of the relief printing plate precursor for laser engraving according to claim 1, and forming a relief layer.

17. The process for making a relief printing plate according to claim 16, wherein engraving is performed with a fiber-coupled semiconductor laser light having a wavelength of 700 to 1,300 nm in the engraving step.

18. A relief printing plate comprising a relief layer produced by the process for making a relief printing plate according to claim 16.
